(19) United States
(12) Patent Application Publication
(10) Pub. No.: US 2016/0164985 A1
(43) Pub. Date: Jun. 9, 2016

(54) SELECTING COMMENTS FOR PRESENTATION TO A SOCIAL NETWORKING SYSTEM USER ALONG WITH A CONTENT ITEM

(71) Applicant: Facebook, Inc., Menlo Park, CA (US)

(72) Inventors: Yisong Song, Menlo Park, CA (US); Meihong Wang, Sunnyvale, CA (US)

(21) Appl. No.: 14/562,538

(22) Filed: Dec. 5, 2014

(51) Int. Cl. H04L 29/08; H04L 12/58; G06F 17/30

(52) U.S. Cl. CPC H04L 67/22; G06F 17/30867; H04L 51/32

(57) ABSTRACT

A social networking system maintains various content items with one or more content items associated with comments provided by social networking system users. When a user requests a content item associated with one or more comments, the social networking system determines likelihoods of the user performing a type of interaction with the one or more comments based on characteristics of the comments. For example, the social networking system determines likelihoods of the user requesting to view one or more of the comments. Based on the determined likelihoods, the social networking system generates an instruction describing presentation of comments. The instruction may identify a set of comments for presentation along with the content item that are selected based on the determined likelihoods.

### BACKGROUND

This disclosure relates generally to presenting content to users of an online system, and more specifically to selecting comments associated with a content item for presentation to a user of the social networking system along with the content item.

Social networking systems have become prevalent in recent years because they allow their users to easily connect to and communicate with other users. Through social networking systems, users share a variety of content items. Examples of content items shared by users through a social networking system include pictures, videos, articles, and status updates. Social networking system users may comment on a content item shared by other users. For example, a user may provide a comment indicating its thoughts on an article shared by another user via the social networking system.

Some content items receive a large number of comments (e.g., one thousand or more comments). For example, a large number of comments may be received for content items including controversial subject matter or posted by a user connected to a large number of additional social networking system users. Hence, when a user attempts to view comments for some content items, the user will likely be overwhelmed by the number of comments and lose interest in viewing the comments. Additionally, if a large number of comments associated with a content item are presented, additional content items may be displaced by the presented comments, reducing a user's ability to view additional content items.

### SUMMARY

To better present comments on received content to a user of a social networking system, the social networking system generates information describing presentation of comments associated with a content item based on a likelihood of the user performing a type of interaction with one or more content items. For example, the social networking system determines whether the user has at least a threshold likelihood of requesting to view comments associated with the content item. Based on characteristics associated with one or more of the comments associated with a content item, the social networking system determines a likelihood of the user performing the type of interaction with the content item. Example types of interactions include: indicating a preference for a comment, indicating a preference for the content item, sharing the content item, providing a comment associated with the content item, and requesting to view a comment. In one embodiment, the social networking system determines likelihoods of the user performing the type of interaction with various comments associated with the content item and determines a likelihood of the user requesting to view the one or more comments based on the determined likelihoods of the user performing the type of interaction. Alternatively, based on characteristics of various comments, the social networking system determines a likelihood of the user requesting to view the one or more comments. Example characteristics of a comment include: an affinity of the user for an additional user associated with the comment, an affinity of the user for an additional user associated with the content item, a number of other users who are connected to the user and who have also provided a comment for the same content item, a time since the comment was made, etc.

In some embodiments, based on the likelihoods of the user performing the type of interaction with various comments associated with the content item, the social networking system generates an instruction to present at least a set of comments associated with the content item when the content item is presented. When a client device receives the instruction and the content item, the client device presents the set of comments associated with the content item. In some embodiments, the instruction identifies a number of content items, and the client device presents the number of content items when the content item is displayed; for example, the content items are maintained in reverse chronological order based on the times associated with comments (e.g., a time when the social networking system received the comment), and the client device presents the identified number of comments based on their associated times. Alternatively, the instruction identifies a set of comments based at least in part on the likelihoods of the user performing the type of interaction with the comments, and the client device presents the identified set of comments along with the content item. For example, the social networking system selects comments associated with at least a threshold likelihood of the user performing the type of interaction. As another example, the social networking system ranks comments associated with the content item based on their associated likelihoods of the user performing the type of interaction and selects comments having at least a threshold position in the ranking

When the social networking system transmits the content item to a client device for presentation to the user, the instruction describing presentation of the comments associated with the content item is also transmitted. The client device executes the instruction and presents comments associated with the content item based on the instruction when the content item is presented. For example, when the content item is presented, a set of comments identified by the instruction is presented along with the content item. Alternatively, when the client device executes the instructions, the client device retrieves the set of comments from the social networking system and locally stores the set of comments to allow the set of comments to be more rapidly presented when requested by the user.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for selecting comments associated with a content item for presentation to a user of a social networking system, in accordance with an embodiment.

FIGS. 4A-4C are examples of presentation of comments associated with a content item to a user based on likelihoods of the user interacting with one or more of the comments, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

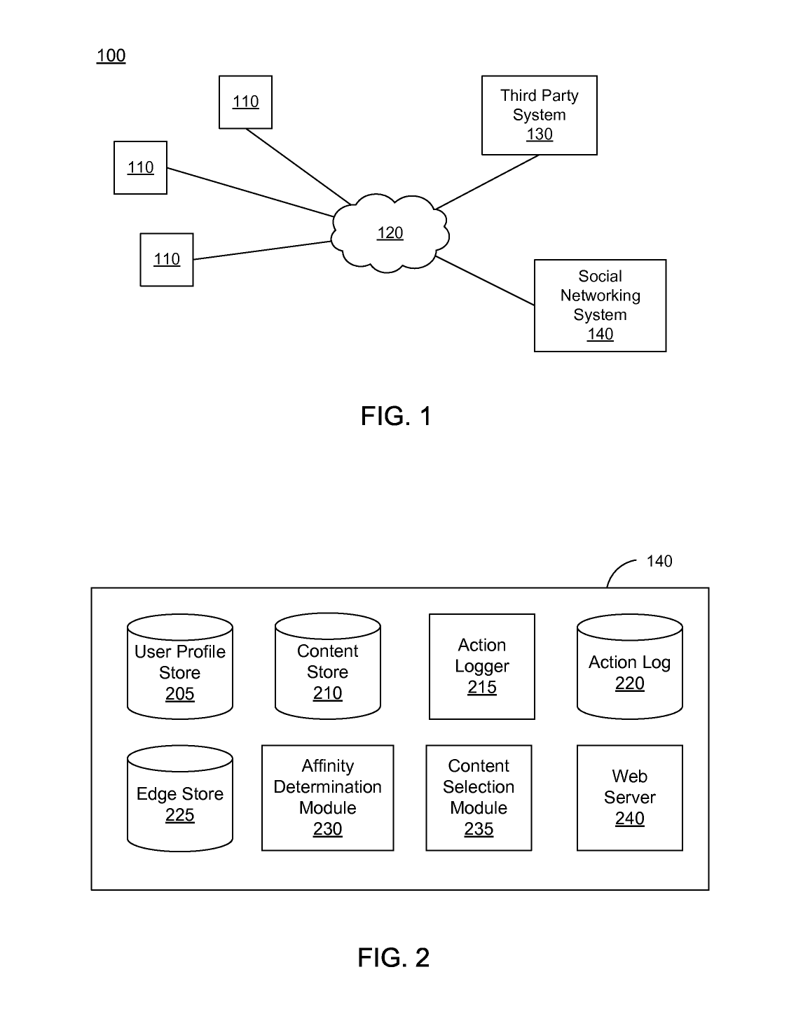

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, information describing a group of users of the social networking system 140, or information about an application provided by the third party system 130. In some embodiments, a third party system 130 may communicate information directly to the social networking system 140.

FIG. 2 is a block diagram of an architecture of the social networking system 140. The social networking system 140 shown in FIG. 2 includes a user profile store 205, a content store 210, an action logger 215, an action log 220, an edge store 225, an affinity determination module 230, a content selection module 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture. In other embodiments, the functionality described herein may be adapted for use by online systems other than social networking systems 140.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220. In some embodiments, a third party system 130 may indirectly retrieve information from the user profile store 205, subject to one or more privacy settings associated with a user profile by a user, to identify a user profile in the user profile store 205 associated with a user of the third party system 130.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

Users of the social networking system 140 may provide comments associated with a content item to the social networking system 140, which stores the comments in the content store 210 in association with the content item. Additionally, a time associated with a comment and information identifying the user who provided the comment are stored in the content store 210 in association with the comment. A comment may be a remark of a user expressing an opinion, a reaction, or any other user-provided data. For example, a comment associated with a content item is text or other data expressing a user's opinion or reaction to the content item. A comment may include text data, image data, video data, audio data, links to other content, or any other suitable information. In some embodiments, users may provide one or more replies associated with a comment, and the replies are stored in the content store 210 in association with the content item and the comment associated with the one or more replies. An additional reply may also be associated with a reply, with the association stored in the content store 210. A reply may include text data, image data, video data, audio data, links to other content, or any other suitable information.

As described herein, a user who provides a comment or reply to the social networking system 140 is also referred to as user “posting” the comment or reply. In one embodiment, for a stored comment or reply the content store 210 includes the time and date when a comment or reply was posted, the user posting the comment or reply, a geographic location associated with the comment or reply, and a type of device used for posting the content or reply. Additional information may also be associated with a comment or reply. Example additional information associated with a comment or a reply include: a number of users that have expressed a preference for the comment or reply, identifiers of users expressing a preference for the comment or reply, the dates and times when the preferences for the comment or reply were expressed, a number of users that have identified a comment as unwanted, user identifiers of users identifying a comment or reply as unwanted, and the dates and times when the comment or reply was identified as unwanted. Information associated with comments or replies may be maintained in the content store 210 based on information stored in the action log 220, which is further described below.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, commenting on a content item, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of an social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest in an object, a topic, or another user in the social networking system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The affinity determination module 230 calculates affinities of users of the social networking system 140 for other users, objects, or content items based on information stored in the action log 320 and the edge store 225. Affinities are computed over time to approximate a user's interest in objects or other users of the social networking system 140. Affinities may be based on a variety of factors. For example, the number of connections to additional users common to a user and another user may be used to determine the user's affinity for the other user. Additional examples of information for determining a user's affinity for another user include: types of connections to additional users shared between the user and the other user, a number of interactions the user has had with the other user, how recently the user and the other user have interacted with each other, and a number of interactions the user has had with content associated with the other user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety.

The content selection module 235 selects one or more content items for communication to a client device 110 to be presented to a viewing user. Content items eligible for presentation to the viewing user are retrieved from the content store 210, or from another source, by the content selection module 235, which selects one or more of the content items for presentation to the viewing user. A content item eligible for presentation to the viewing user is a content item associated with at least a threshold number of targeting criteria satisfied by characteristics of the viewing user or is a content item that is not associated with targeting criteria. In various embodiments, the content selection module 235 includes content items eligible for presentation to the viewing user in one or more selection processes, which identify a set of content items for presentation to the viewing user. For example, the content selection module 235 determines a measure of relevance of various content items to the user based on characteristics associated with the user by the social networking system 140 based on the user's affinities for different content items and selects content items for presentation to the user based on the determined measures of relevance. For example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Additionally, the content selection module 235 generates information describing presentation of one or more comments associated with content items selected for presentation to a user. If a content item is associated with a large number of comments, presenting the comments associated with the content item may displace additional content items. For example, if the social networking system 140 presents content items in a vertically-scrolling feed, presenting comments associated with a content item may cause additional content items in lower-positions in the feed, which may decrease the likelihood of a user viewing or interacting with the additional content items. However, presenting comments associated with a content item may increase the likelihood of a user interacting with the content item or interacting with one or more comments associated with the content item. The information describing presentation of comments associated with a content item may be an instruction to present at least a set of comments or information identifying the set of comments to present.

To generate the information describing presentation of comments associated with a content item, the content selection module 235 determines likelihoods of a user presented with the content item performing a type of interaction with various comments associated with the content item based on characteristics of the comments. Example types of interactions include: indicating a preference for a comment, requesting to view one or more comments, and sharing the content item with another user. For example, one or more machine-learned models are applied to characteristics of comments associated with a content item to determine likelihoods of the user performing one or more types of interactions with various comments. Characteristics of a comment include: an additional user associated with the comment, affinity between the user and an additional user associated with the comment, an additional user associated with a content item with which the comment is associated, a topic associated with the comment, a date or time associated with the comment, or any other suitable information. Additionally, a measure of quality of a comment may be determined and used to determine a likelihood of the user performing the type of interaction with the comment. The measure of quality may be based on characteristics of the comment as well as characteristics of the user to be presented with the content item. For example, the measure of quality is based on prior interactions between the user and additional content associated with an additional user associated with the comment, interactions between the user and additional content having a topic matching or similar to a topic associated with the comment, a location associated with the user, a location associated with the comment, connections between the user and one or more objects associated with the comment, or any suitable information.

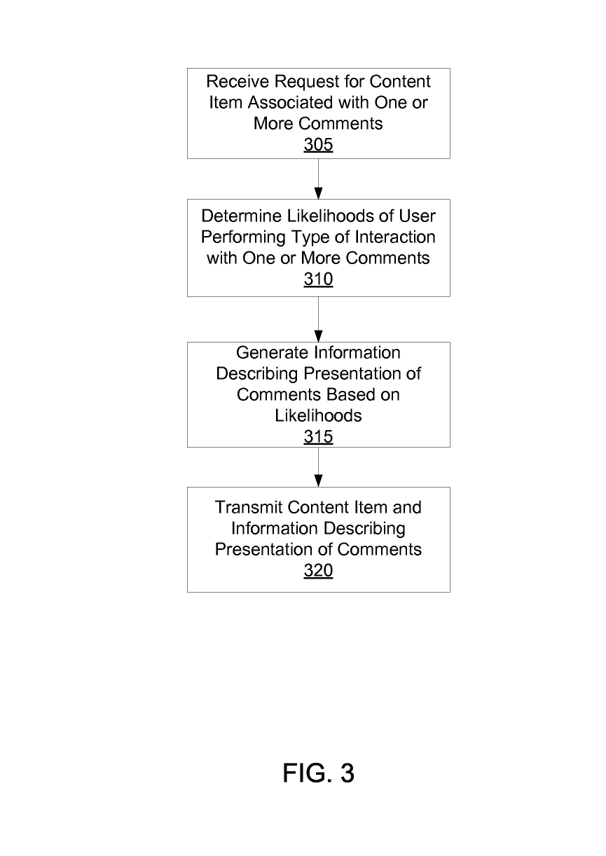

In some embodiments, the content selection module 235 determines a likelihood of the user requesting to view comments associated with the content item and the information describing the presentation of the comments associated with the content item indicates whether to display the comments. For example, based on the likelihoods of the user performing the type of interaction with various comments, the content selection module 235 determines a likelihood of the user requesting to view the comments; if the likelihood of the user requesting to view the comments equals or exceeds a threshold value, the content selection module 235 generates an instruction specifying presentation of at least a set of comments when the content item is presented. The generated instruction is communicated to a client device 110 along with the content item, causing the client device 110 to present at least a set of the comments when the content item is presented. The content selection module 235 may identify a set of comments based on the likelihoods of the user performing the type of interaction with various comments. For example, the content selection module 235 selects comments having associated with at least a threshold likelihood of the user performing the type of interaction. Alternatively, the content selection module 235 ranks the comments based on the likelihoods of the user performing the type of interaction and selects comments having at least a threshold position in the ranking Information describing presentation of the comments may identify the selected comments. Presentation of comments associated with a content item is further described below in conjunction with FIG. 3.

The web server 240 links the social networking system 140 via the network 120 to the one or more client devices 110, as well as to the one or more third party systems 130. In some embodiments, the web server 240 links the social networking system 140 directly to one or more third party systems 130. The web server 240 serves web pages, as well as other content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Determining Presentation of Comments to a Social Networking System User

FIG. 3 is a flow chart of a method for selecting comments associated with a content item for presentation to a user of a social networking system 140. In other embodiments, the method may include different and/or additional steps than those described in conjunction with FIG. 3. Additionally, in some embodiments, the method may perform the steps described in conjunction with FIG. 3 in different orders.

The social networking system 140 receives 305 a request from a user for a content item that is associated with one or more comments. As described above in conjunction with FIG. 2, each comment represents information provided by one or more users of the social networking system 140. For example, the social networking system 140 receives 305 a request to view a feed of content items where a content item in the feed is associated with one or more comments. As another example, the social networking system 140 receives 305 a request to update a feed of content items presented to the user with additional content items or with modifications to content items included in the feed (e.g., comments associated with a content item in the feed subsequent to a time when the content item was communicated to a client device 110 for presentation to the user).

Based on characteristics of the one or more comments associated with the content item, the social networking system 140 determines 310 likelihoods of the user performing a type of interaction with the one or more comments. Example types of interactions with a comment include: indicating a preference for a comment, requesting to view one or more comments, and sharing the content item with another user. One or more machine-learned models may be applied to characteristics of a comment to determine 310 a likelihood of the user performing the type of interaction with the comment. Different machine-learned models may be used to determine 310 likelihoods of the user performing different types of interactions with one or more of the comments. Example characteristics of a comment used by the social networking system 140 to determine 310 a likelihood of the user performing the type of interaction include: the content item associated with the comment, characteristics of the content item associated with the comment, an additional user associated with the comment, affinity between the user and an additional user associated with the comment, an additional user associated with a content item with which the comment is associated, a topic associated with the comment, a date or time associated with the comment, or any other suitable information. A measure of quality of a comment based on its characteristics and characteristics of the user may also be determined and used as a characteristic of the comment when determining 310 a likelihood of the user performing the type of interaction with the comment. For example, the measure of quality is based on prior interactions between the user and additional content associated with an additional user associated with the comment, interactions between the user and additional content having a topic matching or similar to a topic associated with the comment, a location associated with the user, a location associated with the comment, connections between the user and one or more objects associated with the comment, or any suitable information.

In some embodiments, the social networking system 140 determines 310 likelihoods of the user performing the type of interaction with multiple comments associated with the content item. Based on the determined likelihoods of the user performing the type of interaction with multiple comments, the social networking system 140 may determine a likelihood of the user requesting to view one or more of the comments associated with the content item or performing any other suitable type of interaction with the one or more comments. Alternatively, the social networking system 310 may determine a single likelihood of the user performing the type of interaction with the one or more comments based on characteristics of various comments.

Based on the likelihoods of the user performing the type of action with one or more of the comments associated with the content item, the social networking system 140 generates 315 information describing presentation of the one or more comments when the content item is presented to the user. In some embodiments, the information is an instruction specifying whether to present at least a set of the comments when the content item is presented to the user. For example, the social networking system 140 determines a likelihood of the user requesting to view the one or more comments based on the likelihoods of the user requesting to view various comments (or based on likelihoods of the user performing any suitable interaction with various comments associated with the content item). If the likelihood of the user requesting to view the one or more comments equals or exceeds a threshold value, the social networking system 140 generates 315 an instruction to present at least a set of the comments when the content item is presented.

If the generated information specifies presentation of at least a set of the one or more comments, the information may identify a set of the comments to present. For example, the social networking system 140 selects comments associated with at least a threshold likelihood of the user performing the type of interaction for inclusion in the set. As another example, the social networking system 140 ranks the comments based on the likelihoods of the user performing the type of interaction with different comments and selects comments having at least a threshold position in the ranking for inclusion in the set. The generated information may include identifiers associated with comments included in the set or may include the comments themselves. The number of comments included in the set may be determined based at least in part on information associated with a client device 110 used to present the comments (e.g., a type of client device 110). For example, if the client device 110 is a mobile device, a smaller number of content items are included in the set than if the client device 110 is a laptop computer or a desktop computer. In some embodiments, the social networking system 140 retrieves comments included in the set from the content store 210 to subsequently expedite communication of comments in the set to a client device 110 for presentation.

The social networking system 140 transmits 320 the content item and the information describing presentation of comments associated with the content item to a client device 110 associated with the user for presentation. When the client device 110 receives the content item, the content item 110 presents the content item and presents information describing the comments based on the information describing the presentation of the comments. If the information describing presentation of the comments is an instruction to present at least a set of the comments, the client device 110 presents at least the set of the comments when the content item is presented. In one embodiment, the client device 110 presents the set of the content items in reverse chronological order based on the times associated with the comments. In some embodiments, the information describing presentation of comments associated with the content item includes identifiers associated with a set of comments for presentation with the content item or includes the set of comments for presentation. When the content item is presented, content items included in the set are presented, and additional comments not in the set are presented when the social networking system 140 receives a request for the additional comments. Alternatively, the content item is presented without comments associated with the content item unless the information describing presentation of the comments includes an instruction to present at least the set of the comments; however, when a request from the user to present comments is received by the social networking system 140, one or more of the comments are communicated from the social networking system 140 to the client device 110 for presentation. The social networking system 140 may communicate comments to the client device 110 based on the determined likelihoods of the user performing the type of interaction with the comments. Alternatively, the content item is presented with at least a set of comments unless the information describing presentation of comments includes an instruction to prevent presentation of comments. In some embodiments, the information describing presentation of comments includes an instruction that, when executed by the client device 110, causes the client device 110 to retrieve a set of comments from the social networking system 140 and locally store the set of comments to expedite presentation of the set of comments if the user requests presentation of comments associated with the content item.

In some embodiments, the information describing presentation of comments associated with the content item that is transmitted 320 to the client device 110 is based on one or more characteristics of the client device 110. For example, the request for the content item specifies a type of client device 110 from which the request was received 305. The social networking system 140 may modify a number of comments included in the set of comments based on the type of client device 110. For example, if the type of client device 110 indicates the client device 110 is a mobile device, the set of comments includes a number of comments, while the set of comments includes a different, larger, number of comments if the type of client device 110 indicates the client device 110 is a desktop computer or a laptop computer. In other embodiments, the social networking system 140 compares likelihoods of the user performing the type of interaction (or a likelihood of the user performing a type of interaction with the comments) to different threshold values when generating 315 the information describing presentation of the comments based at least in part on the type of the client device 110. For example, the social networking system 140 compares the likelihoods of the user performing the type of interaction to a threshold value if the type of client device 110 is a mobile device and compares the likelihoods of the user performing the type of interaction to an alternative threshold value, which is lower than the threshold value, if the type of client device 110 is a laptop computer or a desktop computer.

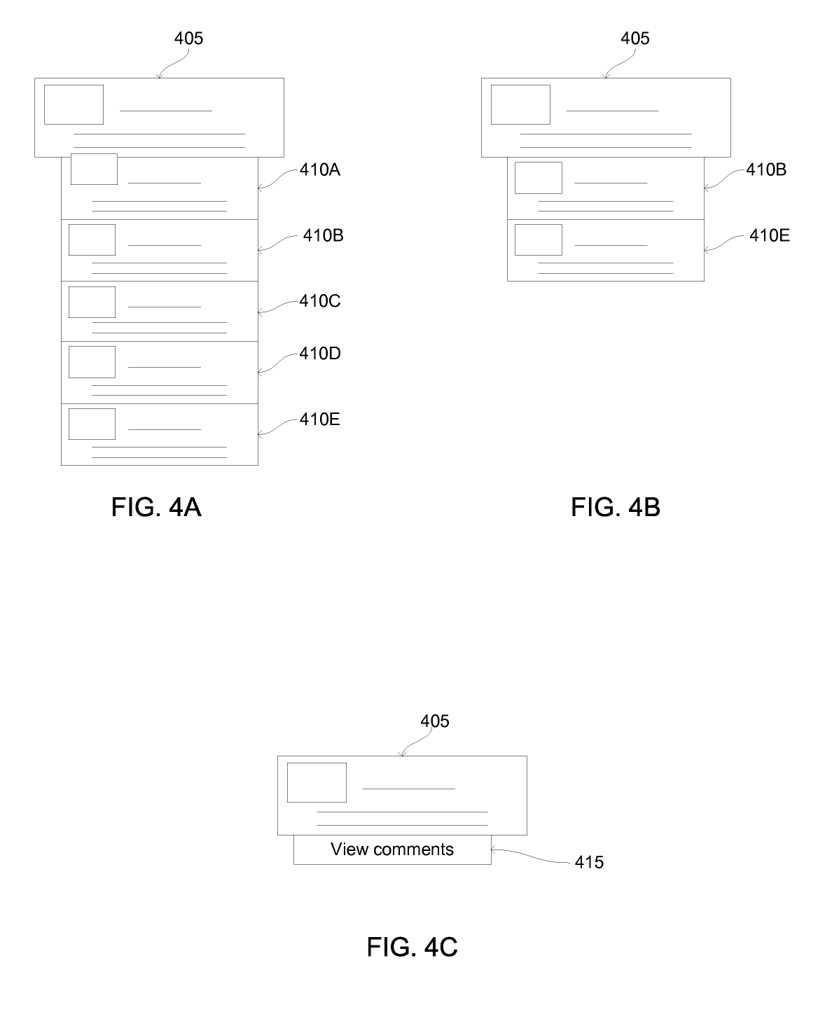

FIGS. 4A-4C show example presentations of comments associated with a content item to a user based on likelihoods of the user performing a type of interaction with one or more of the comments. FIG. 4A is an example of a content item 405 associated with multiple comments 410A, 410B, 410C, 410D, 410E (also referred to individually and collectively herein using reference numeral 410). In an embodiment where information describing presentation of comments identifies a set of comments selected based on likelihoods of the user performing the type of interaction with the comments, when the content item 405 is presented, comments 410 associated with the content item 405 and included in the set are presented. FIG. 4B shows an example where comment 410B and comment 410E are associated with threshold likelihoods of the user performing a type of interaction and are included in in a set of comment items. Hence, in FIG. 4B, comment 410B and comment 410E are presented when the content item 405 is presented. If a request to present additional comments 405 is received by the social networking system 140, comments 410A, 401C, and 410D are presented by the social networking system 140.

FIG. 4C shows an alternative example where the generated information describing presentation of comments associated with the content item 405 is an instruction indicating whether to present comments 410. In some embodiments, the instruction indicates at least a set of comments 410 associated with the content item 405 are presented, so the comments 410A-410E shown in FIG. 4A may be presented along with the content item 405 in some embodiments, or the set of comments (i.e., comment 410B, comment 410E) shown in FIG. 4B are presented along with the content item 405. Alternatively, the instruction indicates that comments are not to be presented with the content item 405, so a prompt 415 to view comments, as shown in FIG. 4C, is presented along with the content item 405 rather than comments 410. In various embodiments, the prompt 415 may identify a total number of comments associated with the content item 405 or any other suitable information. If an interaction with the prompt 415 is received by the social networking system 140, comments are retrieved and presented by the social networking system 140 as in the example of FIG. 4A or FIG. 4B.

### Summary

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A computer-implemented method comprising:
receiving, from a client device of a user of a social networking system, a request for a content item associated with one or more comments representing information provided by users of the social networking system;
determining a likelihood of the user performing a type of interaction with one or more of the comments associated with the content item based at least in part on characteristics of the one or more comments;
generating information describing presentation of the one or more comments associated with the content item based at least in part on the determined likelihoods; and
transmitting the information describing presentation of the one or more comments associated with the content item to the client device along with instructions to present the content item and to present information associated with the one or more comments based on the information describing presentation of the one or more comments associated with the content item.

2. The computer-implemented method of claim 1, wherein determining likelihoods of the user performing a type of interaction with one or more of the comments associated with the content item based at least in part on characteristics of the one or more comments comprises:
determining a likelihood of the user requesting to view the one or more comments based on one or more characteristics of the one or more comments.

3. The computer-implemented method of claim 2, wherein generating information describing presentation of the one or more comments associated with the content item based at least in part on the determined likelihoods comprises:
generating an instruction to present at least a set of the one or more comments if the determined likelihood of the user requesting to view the one or more comments has at least a threshold value.

4. The computer-implemented method of claim 3, wherein the set of the one or more comments is selected based at least in part on the likelihoods of the user performing the type of interaction with one or more of the comments.

5. The computer-implemented method of claim 4, wherein the set of the one or more comments includes comments having at least a threshold likelihood of the user performing the type of interaction.

6. The computer-implemented method of claim 1, wherein generating information describing presentation of the one or more comments associated with the content item based at least in part on the determined likelihoods comprises:
ranking the one or more comments based at least in part on the determined likelihoods;
selecting a set of the one or more comments based at least in part on the ranking; and
generating information identifying the set of the one or more comments.

7. The computer-implemented method of claim 1, wherein a characteristic of a comment comprises an affinity between the user and an additional user associated with the comment.

8. The computer-implemented method of claim 1, wherein a characteristic of a comment comprises an affinity between the user and an additional user associated with the content item.

9. The computer-implemented method of claim 1, wherein the type of interaction with one or more of the comments comprises indicating a preference for one or more of the comments.

10. A computer-implemented method comprising:
receiving, from a client device of a user of a social networking system, a request for a content item associated with one or more comments representing information provided by users of the social networking system;
determining likelihoods of the user performing a type of interaction with one or more of the comments associated with the content item based at least in part on characteristics of the one or more comments;
selecting a set of the one or more comments based at least in part on the determined likelihoods; and
transmitting the set of the one or more comments to a client device associated with the user along with the content item.

11. The computer-implemented method of claim 10, wherein selecting the set of the one or more comments based at least in part on the determined likelihoods comprises:
ranking the one or more comments based at least in part on the determined likelihoods;
selecting the set of the one or more comments based at least in part on the ranking;
and generating information identifying the set of the one or more comments.

12. The computer-implemented method of claim 10, wherein selecting the set of the one or more comments based at least in part on the determined likelihoods comprises:
selecting one or more comments having at least a threshold likelihood of the user performing the type of interaction.

13. The computer-implemented method of claim 10, further comprising:
determining a likelihood of the user requesting to view the one or more comments based on one or more characteristics of the one or more comments; and
transmitting an instruction to the client device to present the set of comments if the likelihood of the user requesting to view the one or more comments equals or exceeds a threshold value.

14. The computer-implemented method of claim 10, wherein a characteristic of a comment comprises an affinity between the user and an additional user associated with the content item.

15. The computer-implemented method of claim 10, wherein a characteristic of a comment comprises an affinity between the user and an additional user associated with the comment.

16. The computer-implemented method of claim 10, wherein the type of interaction with one or more of the comments comprises indicating a preference for one or more of the comments.

17. The computer-implemented method of claim 10, wherein selecting the set of the one or more comments based at least in part on the determined likelihoods comprises:
determining a type of the client device; and
selecting the set based at least in part on the determined likelihoods and the determined type.

18. A computer program product comprising a computer readable storage medium having instructions encoded thereon that, when executed by a processor, cause the processor to:
receive, from a client device of a user of a social networking system, a request for a content item associated with one or more comments representing information provided by users of the social networking system;
determine likelihoods of the user performing a type of interaction with one or more of the comments associated with the content item based at least in part on characteristics of the one or more comments;
select a set of the one or more comments based at least in part on the determined likelihoods; and
transmit the set of the one or more comments to a client device associated with the user along with the content item.

19. The computer program product of claim 18, wherein select the set of the one or more comments based at least in part on the determined likelihoods comprises:
determine a type of the client device; and
select the set based at least in part on the determined likelihoods and the determined type.

20. The computer program product of claim 18, wherein select the set of the one or more comments based at least in part on the determined likelihoods comprises:
rank the one or more comments based at least in part on the determined likelihoods;
select the set of the one or more comments based at least in part on the ranking; and
generate information identifying the set of the one or more comments.
